(19) United States
(12) Patent Application Publication
(10) Pub. No.: US 2014/0039798 A1
(43) Pub. Date: Feb. 6, 2014

(54) SYSTEM AND METHODS FOR GROUPING SIMILAR ITEMS WITHIN A SET

(71) Applicants: Chetan K. GUPTA, San Mateo, CA (US); Ravigopal VENNELAKANTI, Santa Clara, CA (US); Krishnamurthy VISWANATHAN, Mountain View, CA (US); Dhulipala SASTRY, BANGALORE (IN); Umeshwar DAYAL, Saratoga, CA (US)

(72) Inventors: Chetan K. GUPTA, San Mateo, CA (US); Ravigopal VENNELAKANTI, Santa Clara, CA (US); Krishnamurthy VISWANATHAN, Mountain View, CA (US); Dhulipala SASTRY, BANGALORE (IN); Umeshwar DAYAL, Saratoga, CA (US)

(21) Appl. No.: 13/563,678

(22) Filed: Jul. 31, 2012

(51) Int. Cl. G01V 1/28

(52) U.S. Cl. CPC G01V 1/288
USPC 702/14

(57) ABSTRACT

A system is disclosed comprising a non-transitory, computer-readable storage device storing software. The software, when executed by a processor, causes the processor to perform the following operations for each of a plurality of non-functional electronic devices: count a number of other non-functional electronic devices within a defined distance from the non-functional electronic device; and define the non-functional electronic device to be a core electronic device if the counted number is at least a threshold value, wherein threshold value is based on a total number of electronic devices within the defined distance around the non-functional electronic device. For each core electronic device, the software, when executed by a processor, further causes the processor to form a neighborhood group comprising the core electronic device and other non-functional electronic devices within the defined distance around the core electronic device.

### BACKGROUND

Sensors are used for a variety of purposes. For example, networks of spatially-distributed sensors may be used to measure or monitor events across portions of the earth's surface. An example of such sensors is the use of sensors for seismic reflection survey during oil exploration. A common method uses an array of seismic sensors connected by communication and power wires to a repeater or a base station to transmit or collect data. Newer systems use wireless sensors that are often distributed over a larger area. Typically, due to redundancy, the failure of one or a few sensors is non-critical to the data set that is collected. However, a failure of multiple sensors in close proximity can degrade or totally devalue a data set.

### BRIEF DESCRIPTION OF THE DRAWINGS

For a detailed description of various examples, reference will now be made to the accompanying drawings in which:

FIG. 1 shows a system in accordance with an example;

FIG. 2 illustrates clustering performed on objects distributed across a region;

FIG. 3 also shows a system in accordance with an example; and

FIG. 4 shows a method in accordance with various examples.

### DETAILED DESCRIPTION

The following description is exemplary of various embodiments. These embodiments are not to be interpreted or otherwise used as limiting the scope of the disclosure, including the claims. One skilled in the art will understand that the following description has broad application, and the discussion of any embodiment is meant only to be exemplary of that embodiment, and is not intended to suggest in any way that the scope of the disclosure, including the claims, is limited to that embodiment.

Within the drawing figures, certain features and components disclosed herein may be shown exaggerated in scale or in schematic form, and some details of conventional elements may not be shown in the interest of clarity and conciseness. In some of the figures, in order to improve clarity and conciseness of the figure, one or more components or aspects of a component may be omitted or may not have reference numerals identifying the features or components that are identified elsewhere. In addition, like or identical reference numerals may be used to identify common or similar elements.

The terms “including” and “comprising” are used herein, including in the claims, in an open-ended fashion, and thus should be interpreted to mean “including, but not limited to . . . .” Also, the term “couple” or “couples” is intended to mean either an indirect or direct connection. Thus, if a first component couples or is coupled to a second component, the connection between the components may be through a direct engagement of the two components, or through an indirect connection that is accomplished via other intermediate components, devices and/or connections. In addition, if the connection transfers electrical power or signals, whether analog or digital, the coupling may comprise wires or a mode of wireless electromagnetic transmission, for example, radio frequency, microwave, optical, or another mode. So too, the coupling may comprise a magnetic coupling or any other mode of transfer known in the art, or the coupling may comprise a combination of any of these modes. The recitation “based on” means “based at least in part on.” Therefore, if X is based on Y, X may be based on Y and any number of other factors.

Furthermore, in the disclosure and in the claims, the following definitions will apply.

The terms “cluster” and “group” may be used interchangeably to refer to multiple objects or concepts that have been or may be counted, associated, or distinguished. Often the members of a cluster or group have a common characteristic or a common purpose, which in some cases will be distinct from additional objects that are otherwise similar.

The term “non-functional” means that a device, e.g., a sensor, is in a state whereby it is not operating or cannot operate according to its intended design with respect to one or more features of the equipment. For example, a piece of equipment is non-functional when it is in an “off” state or lacks a necessary level of power. As another example, a piece of equipment may be non-functional when it is in an “ON” state and has sufficient power yet the equipment is still unable to operate according to its intended design, possibly as a result of a malfunction, a broken component, or a disconnected or disabled communication mode, or due to another failure mode. As another example, a sensor that cannot acquire measurement data or cannot transmit measurement data is non-functional even if other features of the sensor are operating or appear to operate normally.

The term “null data” refers to information received from or assigned to a device, such as a sensor, indicating that the device is non-responsive during a period of data collection. Null data is distinguishable from data having a magnitude of zero that may be associated with a similar device that provides a response.

The term “sensor” means a piece of equipment that can detect a stimuli and produce a response that is correlated to the type, magnitude, direction, or any binary or any variable characteristic of that stimuli. An example using seismic sensors is discussed below, but the principles described herein apply to other types of sensors and even other types of devices besides sensors.

A multiplicity of sensors is sometimes employed when observing events or phenomena across a region. To cover larger regions or to achieve greater resolution of data, the number of sensors is often increased. One such application is the use of wireless sensors in a seismic reflection survey when exploring for subterranean deposits of oil. For this application, wireless seismic sensors may be distributed across a large area of the earth's terrain. Because such sensors are wireless, the spacing between, and thus the number of, sensors is not limited as is the case when cabling is used. During an operation, a “thumping truck” imparts an impact on the surface of the earth. This impact travels like a sound wave, radiating downward and outward through the dirt and rock formations with a portion of the pulse reflecting back to the surface when discontinuities in the formations are reached and impacted. The reflected pulses travel generally upward and at an angle that mirrors the angle of incidence, i.e., the angle of impact. The sensors spread around the location of the thumping truck sense the vibrations from reflected pulses, providing a response or data indicating the structure and depth of the subterranean formations. The sensors may be located at considerable distances from the truck or from the location where sensor data is debriefed, collected, and processed.

The quality of final results of the seismic survey depend upon accuracy, sensitivity, and reliability of the sensors and reliability of the data recording and retrieval system. Thus, a preferred mode of operation includes monitoring the functional status or health of the sensors, detecting sensor failures, and responding promptly to reach problem zones and to resolve the problems. Of particular importance and value, is the ability to detect whether a collection of sensors, in close proximity to each other, have failed. Such an occurrence is termed a “sensor cluster failure,” which can cause a reduction in the effective coverage area of the seismic survey. For a high density sensor cluster failure, the result may be a “dead zone,” in which minimal or no reliable mapping can be performed for a portion of the subterranean geological profile. The economic impact of dead zones merits diligent attention to sensor cluster failure and prompt repair. The use of wireless sensors for a seismic reflection survey thus benefits from a rigorous level of monitoring and maintenance planning due to the potentially large number of sensors involved and the large distribution area of the sensors.

In accordance with various implementations, a new system and method for performing data quality assessment includes the ability to monitor the health of the distributed sensors and evaluate the density of non-functional sensors in various portions of a distribution region. The system is configured to sample periodically the sensors and to make a determination for each sensor, indicating whether the sensor is “good,” i.e., properly functioning, or is “bad,” i.e., non-functional. The result of the monitoring process is a snapshot of the sensor field indicating which sensors are dead at a given instance. Another feature of the system is the ability to distinguish and locate sub-regions containing large numbers of dead sensors or large numbers of sensors that appear to be dead in close proximity to each other. Once such sub-regions are located, diagnosis in comparison with the state of other system components is performed to identify causes of failure. If failure is due to data carrier or data communication systems, the failure can be redressed by remedial measures such as repair or by using standby equipment, thus saving valuable production time. If the failure appears to be the result of the sensors themselves, a maintenance crew may be sent to the region to investigate and perform repairs.

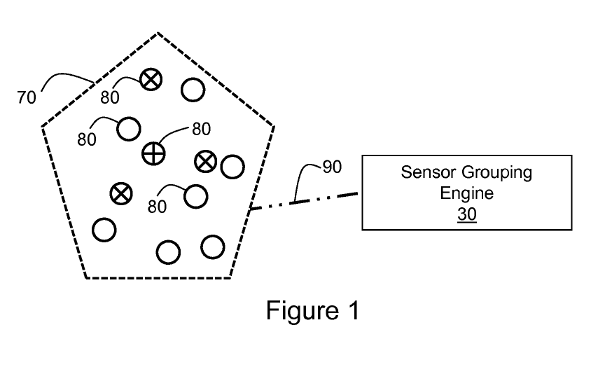

Various implementations of the system and method use a new density-based clustering or grouping technique that flexibly handles variations in sensor distribution density and variations in the distribution region, which may influence the preferred size of the neighborhoods. FIG. 1 shows a system in accordance with an example. The system of FIG. 1 shows a sensor grouping engine 30, multiple sensors in a distribution region 70, and a communication link 90. In this example, the multiple sensors are wireless seismic sensors 80 spatially disperse across region 70, which is a geographical region of any shape. A system may contain any suitable number of sensors 80, for example small system may have 100 or fewer sensors while other systems may have more than 100 sensors 80 (e.g., 40,000 sensors). Wireless seismic sensors 80 are sensitive to vibrations and may be used to detect features of subterranean formations beneath the distribution region 70 and, in some situations, may be used to detect features extending beyond region 70. Sensors 80 are coupled to sensor grouping engine 30 by communication link 90. Communication link 90 represents wired, wireless, or any suitable communication mode and/or hardware capable of transferring data between sensors 80 and sensor grouping engine 30. In one implementation, communication link 90 represents direct wireless communication between sensors 80 and sensor grouping engine 30. In other implementations, communication link 90 includes a sensor control system 92 or one or more signal repeater unit that exchanges data with sensors 80 and also exchanges data with sensor grouping engine 30 so that the coupling between sensors 80 and engine 30 is indirect. Communication link 90 may comprise satellite communication in various embodiments.

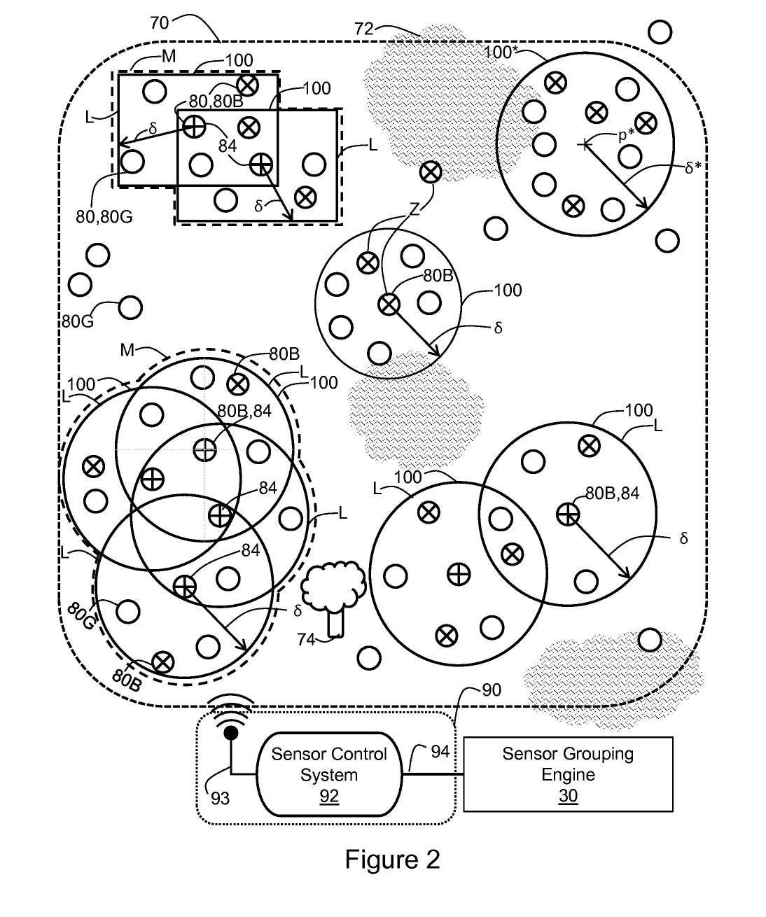

In FIG. 2, communication link 90 comprises a sensor control system 92 that comprises and antenna 93 to wirelessly exchange data with sensors 80 and a cable 94 to couple to sensor grouping engine 30. In other implementations, control system 92 and engine 30 are coupled wirelessly for communication.

As shown in FIG. 2, in various instances, the multiple seismic sensors 80 comprise both functional sensors or “good” sensors 80G and non-functional sensors or “bad” sensors 80B. The status of a sensor 80G, 80B may change according to operational, environmental, and maintenance conditions and circumstances so that at various times, some previously functional sensors 80G may become non-functional sensors 80B, and some previously non-functional sensors 80B may become functional sensors 80G. Sensor grouping engine 30 is configured to evaluate the status of sensors 80 at a point in time or to track the on-going and changing status of sensors 80 over a period of time. In some embodiments, tracking the status of sensors 80 is augmented by the sensor control system 92. By tracking the status of sensors 80, non-functional sensors 80B may be identified and selected by the sensor grouping engine 30 or by the sensor control system 92. A procedure for identifying the status or for selecting non-functional sensors 80B from among the total set of sensors 80 will be described subsequently.

Referring to FIGS. 1 and 2, during operation, the sensor grouping engine 30 performs a sensor grouping algorithm in which engine 30 evaluates the proximity of multiple non-functional sensors 80B and forms (e.g., identifies) logical groups or clusters of adjacent non-functional sensors 80B. For the sensor grouping algorithm, sensor grouping engine 30 establishes a relational function that defines a neighborhood 100 associated with each non-functional sensor 80B. The relational function may, for example, be based on one or more of following, considered individually or in any combination: attributes of sensors, other system components, and data from the sensors or system components, operational states of the sensors or system components, or derived attributes from the data. In FIG. 2, the relational function is a defined distance, which is broadly represented by distance function 6 (lower case Greek letter “delta”). In addition to location, distance function 6 may also consider one or more other attributes of the sensors. Distance function 6 may be the same for all sensors 80B or may be permitted to differ for each sensor and may be permitted to vary according to, for example, an angular measurement around the sensor 80B. Distance function 6 may be influenced by one or more spatially varying features of earthen terrain 72 or may be influenced by non-sensor objects 74 or obstacles in the vicinity of the particular sensor 80B. In FIG. 2, a tree is shown as a non-sensor object 74. Other objects or obstacles 74 may include a cell phone tower, a river, or a cliff, for example. In a simple form, applicable in some instances, distance function 6 is a constant value, i.e., a fixed distance, selected by engine 30 from stored data or accepted from the user.

For each selected non-functional sensor 80B, engine 30 determines and counts the number of other non-functional sensors 80B, which are also called “bad neighbors,” within the corresponding neighborhood 100, that is to say within a defined distance of the selected non-functional sensor 80B. For convenience, the number of bad neighbors will be designated by variable N_{bad}. Potentially, a unique value of the number N_{bad} is determined for each sensor 80B. In some situations, the value of number N_{bad} for a selected sensor 80B may equal zero. In some implementations, the counted value of number N_{bad} for a selected sensor 80B will be increased by a value of one to account for the selected sensor 80B itself. Engine 30 defines the particular sensor 80B to be a “core sensor” 84 when the counted number of bad neighbors is equal to or greater than a threshold value, which will be designated by the lower case Greek letter “mu,” i.e., μ.

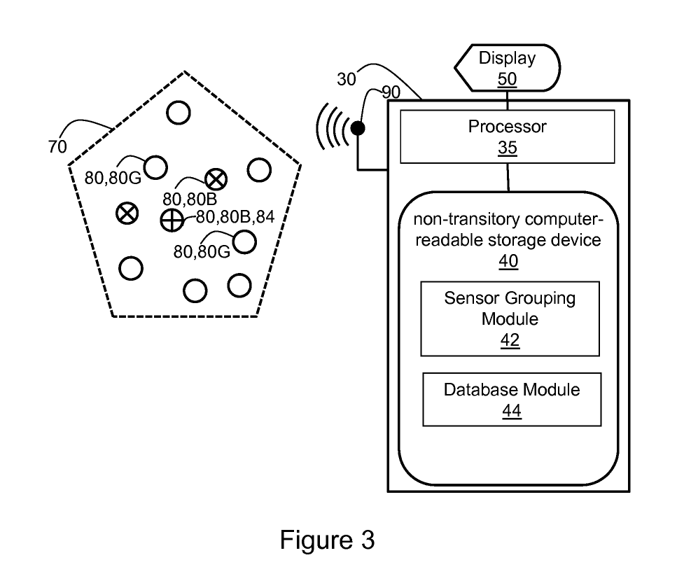

FIG. 3 shows an illustrative implementation of the system of FIG. 1. The system of FIG. 3 shows a processor 35 coupled to non-transitory computer-readable storage device 40 and a display 50. The storage device 40 may include volatile storage (e.g., random access memory), non-volatile storage (e.g., hard disk drive, Flash storage, optical disc, etc.), or combinations of volatile and non-volatile storage. Storage device 40 may be implemented as a single storage device or as multiple storage devices, with the contents distributed across multiple such storage devices.

The storage device 40 includes a sensor grouping module 42, which may comprise software executable by processor 35. As such, the processor 35 combined with the sensor grouping module 42 comprises an example of an implementation of the sensor grouping engine 30. The sensor grouping module 42 causes the processor 35 to perform a sensor grouping algorithm on the non-functional sensors 80B in distribution region 70 as explained above with regard to the sensor grouping engine 30 and as further explained subsequently. In this process, for each core sensor 84, the sensor grouping module 42 causes the processor 35 to form a neighborhood group, L, comprising the core sensor 84 and the other non-functional sensors 80B within the defined distance around the core sensor 84. In forming a neighborhood group L for each core sensor 84, the processor 35 clusters the core sensor and its bad neighbors, all of which are non-functional. Each neighborhood group, L, is a cluster.

In FIG. 3, storage device 40 also includes database module 44, which includes data, i.e., information, describing the positions and status of sensors 80 within distribution region 70. Database module 44 may be populated, i.e., given data, and maintained by sensor grouping engine 30 or, in some embodiments, by sensor control system 92. Sensor grouping engine 30 may access information in database module 44 while executing the instructions in sensor grouping module 42 to perform the sensor grouping algorithm mentioned earlier. Sensor grouping module 42 may instruct engine 30 to store the results of the sensor grouping algorithm within database module 44, to present the results on display 50, or to deliver the results using any other method known in the art, including sending by e-mail, sending by facsimile machine, sending a message via a voicemail system, or sending by text message to a telephone, for example.

The display 50 includes one or more display devices used to convey information to an operator or an observer. The display 50 may be implemented using one or more display technology known in that art, such as liquid crystal, cathode ray, plasma, organic light emitting diode, vacuum fluorescent, electroluminescent, a printer that provides a copy of results on a media such as paper, or any other display technology suitable for providing information to a user. In some embodiments, display 50 may be incorporated into a computing device such as a personal computer, a portable computer pad, or a smart telephone, for example.

To explain the sensor grouping algorithm in more detail, reference is again made to FIG. 2. As mentioned earlier, the position of each seismic sensor 80 is defined according to its placement on the earth's terrain 72, which may be defined by latitude and longitude with respect to the earth as a whole or by a local set of coordinates. Since the terrain of the earth can be assumed to be generally fixed for purposes of this disclosure, the use of latitude and longitude for a particular position also establishes the elevation of the position or sensor. The position data for each sensor 80B stored in database module 44 may be established by any survey technique known in the art. In some embodiments a global positioning satellite (GPS)-coupled sensor adjacent each sensor 80 provides the position data. Position data may be established while initiating a seismic study or may be received throughout the study.

During a seismic study, sensor grouping engine 30 receives status information regarding the multiple sensors 80. As indicated in FIG. 2, the status information may be received with the aid of sensor control system 92. The status information results from one or more of multiple techniques. First, each sensor 80 is designed to transmit operational data including seismic vibration responses. If a vibration response of any magnitude including zero is received from a particular sensor 80, processor 35 may designated the sensor as being a functional sensor 80G. If no such data is received from a particular sensor 80, the result may be designated or stored as null data for that sensor. Processor 35 may designate a sensor 80 having no data or having null data as being a non-functional, i.e., a bad, sensor 80B. In a second technique utilized in some embodiments, sensors 80 incorporate and transmit an error code within the operational data. The value of the error code designates the status of the sensor under various circumstances. For example, an error code of zero may designate a healthy, functional sensor while one or more other code may designate a problem. The value of the error code may be numeric, alphabetic, alpha-numeric, or any other piece or combination of distinguishable and suitable data. When available, the value of the error code may be used by processor 35 to classify a sensor 80 as a functional sensor 80G or a bad sensor 80B.

Thus as instructed by the software in the non-transitory, computer-readable storage device 40, processor 35 obtains or compiles a data set comprising operational data or null data for each member of the total set of sensors 80 in distribution region 70. By evaluating this data set, processor 35 selects the non-functional sensors 80B from among the total set of sensors 80. This selection process may also be referred to as identifying or grouping the non-functional sensors 80B. The processor 35 further selects the functional sensors 80G from among the total set of sensors 80. This selection process may also be referred to as identifying or grouping the functional sensors 80G. The resulting selection information about the non-functional sensors 80B and about the functional sensors 80G may be stored in database module 44 of storage device 40.

Data from one or more sensor 80 may be temporarily unavailable to sensor grouping engine 30 or to sensor control system 92 even though the sensor or sensors continues to be functional during other time periods. The temporarily unavailability may be due to an intermittent or temporary communication blockage, for example. Therefore, in various embodiments, the status evaluation of each sensor as being either a functional (i.e., good) sensor 80G or a non-functional (i.e., bad) sensor 80B by engine 30 or control system 92 may be performed using a filtering technique to distinguish a period of temporary unavailability from a continuing problem. For this purpose, multiple data (e.g., vibration responses or error codes) may be collected from each sensor 80 over a period of time. Optionally, multiple null data corresponding to any sensor 80 may be observed over multiple data collection periods during which data may be successfully collected from various other sensors 80. The time period of a status evaluation may be 5 to 10 minutes in some instances, but the time period may be less than 5 minutes or more than 10 minutes in other instances. The filtering technique may involve averaging the values of the data received for each sensor 80 or may involve confirming that a prescribed portion of the data received indicates the sensor is healthy or, alternatively, is bad.

As introduced earlier, a relational function is established to define a neighborhood 100 associated with each non-functional sensor 80B. The relational function in FIG. 2 is the distance function 6. Also introduced was a threshold value μ that acts as a comparison value when evaluating the density of bad sensors 80B in the various neighborhoods 100 around each non-functional sensor 80B. So, when sensor grouping engine 30 finds a bad sensor 80B, distance function 6 and threshold value μ help engine 30 to qualify how significant is the number of other sensor failures in that vicinity. A neighborhood 100 with a relatively high density of sensor failures merits maintenance prior to another neighborhood 100 having a lower density of sensor failures. As will be explained subsequently, bad sensors 80B from multiple, adjacent neighborhoods 100 may be clustered together to further distinguish the maintenance needs of various sub-regions of distribution region 70.

To set the value of threshold μ, a decision is made regarding what portion or what percent of seismic sensors 80 should be operational in order to maintain the quality of the overall seismic study. If, for example, the preferred answer is that 60% of all sensors in each neighborhood 100 should be operation, then the action limit for failures is 40%. When sensor failures in a neighborhood 100 reach or exceed, the action limit, that neighborhood may be designated as needing maintenance. The action limit for failures will also be called the “threshold density,” and will be designated by the parameter μᵣₐₜᵢₒ. The threshold density μᵣₐₜᵢₒ may be set to any suitable value from zero percent to 100% or, equivalently, from zero to one. The threshold value μ for a sensor 80B may be set at least partially based on the threshold density μᵣₐₜᵢₒ, as will be explained later.

In some situations, the sensor grouping engine 30 determines the threshold density μᵣₐₜᵢₒ and ultimately the threshold value μ based on a ratio of a number of non-functional sensors 80B to a number of total sensors 80 associated with a reference point, p*. The reference point p* may be located within distribution region 70 and may coincide with the position of one of the non-functional sensors 80B. In other circumstances, reference point p* may be outside distribution region 70 and may be associated with another seismic study.

In FIG. 2, a reference point p* is established within distribution region 70 at a position that does not coincide with any sensor 80. A neighborhood 100* surrounds reference point p*. Neighborhood 100* is prescribed by a relational function, specifically distance function δ*. The distance function δ* may be similar in nature or may be similar in value to the distance function δ associated with one or more of the non-functional sensors 80B in region 70. Within this neighborhood 100*, sensor grouping engine 30 determines and counts the total number of sensors 80 around reference point p*, the number being designated herein by the parameter N_{total*}. Also within neighborhood 100*, sensor grouping engine 30 determines and counts the number of non-functional sensors 80B around reference point p*. The number of these “bad neighbors” of p* is designated by the parameter N_{bad*}. From these results, value of the threshold density μᵣₐₜᵢₒ may be calculated by the sensor grouping engine 30 as:

μᵣₐₜᵢₒ=N_{bad*}/N_{total*} (1)

In addition to counting the number of the bad neighbors N_{bad} within the neighborhood 100 for each non-functional sensor 80B, which was described earlier, sensor grouping engine 30 also counts the total number of sensors, Nₜₒₜₐₗ, in the neighborhood 100. The number Nₜₒₜₐₗ is potentially different for each sensor 80B. Using these variables, the threshold value μ for each non-functional sensor 80B is evaluated by the sensor grouping engine 30 using the formula:

μ=Nₜₒₜₐₗ·μᵣₐₜᵢₒ (2)

The threshold value μ is permitted to differ for each selected sensor 80B and, therefore, is potentially unique for each non-functional sensor 80B. Equation 2 states that threshold value μ is based on a total number of sensors Nₜₒₜₐₗ within the corresponding neighborhood 100, that is to say, within a defined distance of the selected non-functional sensor 80B.

As introduced earlier, each non-functional sensor 80B has a number of the bad neighbors N_{bad} in its neighborhood 100. The designation of a neighborhood group L for each core sensor 84 was also explained earlier. Sensor grouping engine 30 may perform additional clustering by associating multiple neighborhood groups L that contain multiple core sensors 84. In this manner, the associated multiple neighborhood groups L form a larger cluster M. Multiple, separate clusters M may be formed as shown in FIG. 2. To form a cluster M, sensor grouping engine 30 again assesses the bad neighbors of each core sensor 84. If any of the bad neighbors of the core sensor 84 is found to be core sensor, the respective neighborhood groups L are joined to form a cluster M. The bad neighbor assessment process is continued for each core sensor that is joined to the cluster M so that any other neighboring core sensors 84 along with their associated neighborhood groups L are also added to cluster M. The search for members of each cluster M may be an iterative process. For a cluster M, each core sensor 84 is within the neighborhood group L of at least one other core sensor 84.

Thus, when at least two core sensors 84 are bad neighbors of one another Sensor grouping engine 30 forms a cluster M including the core sensors 84 such that each core sensor 84 of the cluster M is a bad neighbor of at least one other core sensor 84 of the cluster M. For each core sensor 84 joined to the cluster, engine 30 adds, to the cluster, the other non-functional sensors 80B that are bad neighbors of that core sensor 84.

After all possible clusters L and clusters M are formed, any non-functional sensors 80B that are not associated with a cluster L, M will be grouped in to a noise-cluster N by sensor grouping engine 30. In keeping with previous assessments of the sensors 80, a sensor 80B that is assigned to the noise-cluster N is not a core sensor 84 and is not in the neighborhood 100 of a core sensor 84.

Assuming multiple cluster L, M are established, sensor grouping engine 30 may, as directed by software in storage device 40, sort the clusters L, M according to the total number of non-functional sensors 80B in each cluster L, M. The sorting or the total numbers for the clusters may be used to prioritize further assessment or repair of the non-functional sensors 80B. The further assessments may include engine 30 running diagnostics tests on the sensors 80B, possibly aided by sensor control system 92.

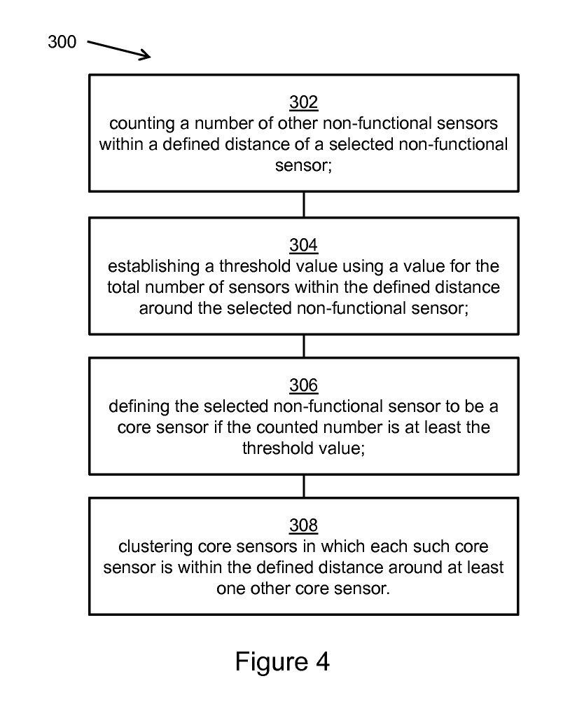

FIG. 4 shows a method 300 in accordance with an example. The actions depicted in FIG. 4 may be performed in the order shown, or in a different order, and two or more of the actions may be performed in parallel, rather than serially. The actions depicted in FIG. 4 may be performed by the sensor grouping engine 30.

For each non-functional sensor 80B selected from within distribution region 70, method 300 at 302 includes counting a number of other non-functional sensors within a defined distance of the selected non-functional sensor 80B. At 304, the method includes establishing a threshold value using a value for the total number of sensors, i.e., both functional and non-functional sensors, within the defined distance around the selected non-functional sensor. At 306, the method includes defining the selected non-functional sensor to be a core sensor if the counted number is at least a threshold value. At 308, the method includes clustering core sensors 84 in which each such core sensor 84 is within the defined distance around at least one other core sensor 84. For example, forming one or more clusters M.

In the figures, the quantities of total sensors 80, functional sensors 80G, non-functional sensors 80B, and core sensors 84 in any distribution region 70, any neighborhood 100, or any cluster L, M, Z are approximate. So, while the figures illustrate the concepts of the several equations described herein, the depicted quantities of sensors 80, 80G, 80B may not mathematically coincide with the equations. In reference to FIG. 2, neighborhoods 100 defined by distance functions 6 have been shown for only some of the non-functional sensors 80B. So it is possible in FIG. 2 that one or more neighborhoods 100 have been omitted for one or more non-functional, core sensors 84. In some embodiments, one or more sensor 80 may be ignored by sensor grouping engine 30 as may be specified by sensor grouping module 42. The ignored sensor or sensors 80 may be inside or outside region 70.

In addition to performing data quality assessments to evaluate the health of distributed sensors and the density of non-functional sensors, at least one implementation of the new method described herein applies broadly to various other electronic devices and systems, for example, cellular telephones, displays, and lighting systems.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. A system, comprising:
a sensor grouping engine to, for each of a plurality of non-functional sensors:
establish a relational function that defines a neighborhood associated with the sensor;
count a number of bad neighbors of the sensor wherein the bad neighbors comprise other non-functional sensors located within the neighborhood of the sensor; and
define the sensor to be a core sensor when the counted number of bad neighbors is at least a threshold value wherein the threshold value is determined by the sensor grouping engine based on a total number of sensors within the neighborhood of the non-functional sensor.

2. The system of claim 1 wherein the sensor grouping engine also performs the following task:
form a cluster of the core sensors such that each core sensor of the cluster is a bad neighbor of at least one other core sensor of the cluster.

3. The system of claim 2 wherein the sensor grouping engine also performs the following task:
for each core sensor of the cluster, add to the cluster the other non-functional sensors that are bad neighbors of the core sensor.

4. The system of claim 1 wherein the threshold value is based on a ratio of a number of non-functional sensors to a number of total sensors associated with a reference point.

5. The system of claim 1 wherein the threshold value is further determined as the product of the total number of sensors within the neighborhood of the non-functional sensor multiplied by a ratio of a number of non-functional sensors to a number of total sensors associated with a reference point

6. The system of claim 1 wherein the threshold value is determined by the sensor grouping engine and differs for at least two of the non-functional sensors.

7. A non-transitory, computer-readable storage device storing software that, when executed by a processor, causes the processor to:
for each of a plurality of non-functional electronic devices:
count a number of other non-functional electronic devices within a defined distance from the non-functional electronic device; and
define the non-functional electronic device to be a core electronic device if the counted number is at least a threshold value,
wherein threshold value is based on a total number of electronic devices within the defined distance around the non-functional electronic device; and
for each core electronic device, form a neighborhood group comprising the core electronic device and other non-functional electronic devices within the defined distance around the core electronic device.

8. The non-transitory, computer-readable storage device of claim 7 wherein the software, further causes the processor to form one or more cluster of the neighborhood groups wherein for each cluster of the neighborhood groups each core electronic device is within the neighborhood group of at least one other core electronic device.

9. The non-transitory, computer-readable storage device of claim 7 wherein the threshold value is further based on a ratio of a number of non-functional electronic devices to a number of total electronic devices in the vicinity of a reference point.

10. The non-transitory, computer-readable storage device of claim 7 wherein the software, further causes the processor to determine a potentially unique threshold value for each non-functional electronic device.

11. The non-transitory, computer-readable storage device of claim 7 wherein the software, further causes the processor to:
compile a data set comprising operational data or null data for each of a plurality of electronic devices; and
select each of a plurality of non-functional electronic devices from among the plurality of electronic devices by evaluating the data set.

12. The non-transitory, computer-readable storage device of claim 8 wherein the software, further causes the processor to:
sort a plurality of clusters according to the number of non-functional electronic devices in each cluster.

13. A method, comprising:
for each selected non-functional sensor:
counting a number of other non-functional sensors within a defined distance of the selected non-functional sensor; and
establishing a threshold value using a value for the total number of sensors within the defined distance around the selected non-functional sensor;
defining the selected non-functional sensor to be a core sensor if the counted number is at least the threshold value; and
clustering core sensors in which each such core sensor is within the defined distance around at least one other core sensor.

14. The method of claim 13 wherein clustering includes clustering other non-functional sensors that are located within the defined distance around at least one of the clustered core sensors.

15. The method of claim 13 further comprising setting the threshold value based on a ratio of a number of non-functional sensors to a number of total sensors around a reference point.

16. The method of claim 15 wherein setting the threshold value further comprises calculating the multiplicative product of the ratio and of the total number of sensors within the defined distance around the selected non-functional sensor.

17. The method of claim 13 comprising setting the threshold value, wherein the threshold value is potentially unique for each non-functional sensor.

18. The method of claim 13 further comprising:
obtaining a data set comprising operational data or null data for each of a plurality of total sensors wherein the total sensors potentially comprises functional sensors and non-functional sensors; and
selecting each of a plurality of non-functional sensors by evaluating the data set.

19. The method of claim 13 wherein the non-functional sensors are spatially disperse across an earthen terrain, the earthen terrain having one or more spatially varying features;
wherein the defined distance for each non-functional sensor is influenced by at least one of the following:
one or more spatially varying feature of the earthen terrain and one or more object in the vicinity of the sensor.

20. The method of claim 13 further comprising forming a noise-cluster comprising the non-functional sensors not disposed within the defined distance around a core sensor.
